(19) United States
(12) Patent Application Publication
(10) Pub. No.: US 2015/0053539 A1
(43) Pub. Date: Feb. 26, 2015

(54) ADHESIVELY ATTACHED LENS WITH FINISHING LAYER

(71) Applicants: James Frederick Krier, Grosse Pointe Woods, MI (US); Daren Lee Harris, Gilbert, AZ (US)

(72) Inventors: James Frederick Krier, Grosse Pointe Woods, MI (US); Daren Lee Harris, Gilbert, AZ (US)

(21) Appl. No.: 14/010,277

(22) Filed: Aug. 26, 2013

(51) Int. Cl. H01H 13/02; B32B 37/14; B32B 37/12

(52) U.S. Cl. CPC H01H 13/023; B32B 37/1284; B32B 37/14; H01H 2221/07
USPC 200/314; 156/60

(57) ABSTRACT

An input mechanism device and a method for providing an edge-to-edge input mechanism are provided. The device includes a lens at a surface facing an engager of the input mechanism; a finishing layer opposite the surface, applied on the lens; an adhesive layer on the finishing layer; a sub-retainer, the sub-retainer and the adhesive layer being bonded with each other via adhesive properties associated with the adhesive layer; and a button retainer to engage with the sub-retainer in response to the engager of the input mechanism applying pressure on the lens.

### BACKGROUND

Input mechanisms, such as buttons and the like, are added to consumer electronics to aid in the functioning and aesthetic appeal. Often times, the input mechanisms are lighted and displayed in an ornamental option. The input mechanisms may be projected from the consumer electronic device.

In response to being engaged, the input mechanism may mechanically actuate a switch, such as an electrical one, and instigate an electronically actuated signal. The electronic signal may be propagated and employed to control a system of the consumer electronic device.

In certain applications, the implementer of the input mechanism may request an aesthetically pleasing look. In these cases, a lens may be employed. The lens may be transparent, or substantially transparent, and allow light to pass through. Behind the lens, a painted finish may be applied as well. The painted finish provides a decorative look to the input mechanism.

Input mechanisms of the type described above are often implemented in vehicle interiors. A vehicular manufacture, or consumer parts supplier may desire input mechanisms that are aesthetically pleasing to increase sales for the respective vehicle or part. By employing a lens with colored finishing paint for the input mechanism, the vehicle and the part may realize greater sales.

### SUMMARY

An input mechanism device and a method for providing an edge-to-edge decorating method input mechanism are provided. The device includes a lens at a surface facing an engager of the input mechanism; a finishing layer opposite the surface, applied on the lens; an adhesive layer on the finishing layer; a sub-retainer, the sub-retainer and the adhesive layer being bonded with each other via adhesive properties associated with the adhesive layer; and a button retainer to engage with the sub-retainer in response to the engager of the input mechanism applying pressure on the lens.

### DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1(a) illustrates a side-view of an input mechanism employing a lens and a finishing layer

FIG. 1(b) illustrates a front-view of the input mechanism of FIG. 1(a).

FIG. 2(a) illustrates an example implementation of a side-view of an input mechanism.

FIG. 2(b) illustrates a front-view of the input mechanism of FIG. 2(a).

FIG. 3 illustrates a side-view of an input mechanism according to another example implementation.

FIG. 4 illustrates a method for providing an edge-to-edge decorating method for an input mechanism.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The aspects disclosed herein are described more fully hereinafter with reference to the accompanying drawings, in which embodiments of the invention are shown. These aspects may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that for the purposes of this disclosure, “at least one of each” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, YZ, X).

Input mechanisms, such as buttons employed with consumer electronics, may incorporate a lens on an exterior portion visible to the actuator of the input mechanism. As explained above, the employing of a lens provides an aesthetically pleasing user experience.

In order to augment the lens implementation, a finishing paint layer may also be employed. The finishing layer is placed on an opposite surface of the lens to the surface in which the operator of the consumer electronic device touches the lens. The finishing layer may be a decoration or indication associated with the input mechanism function.

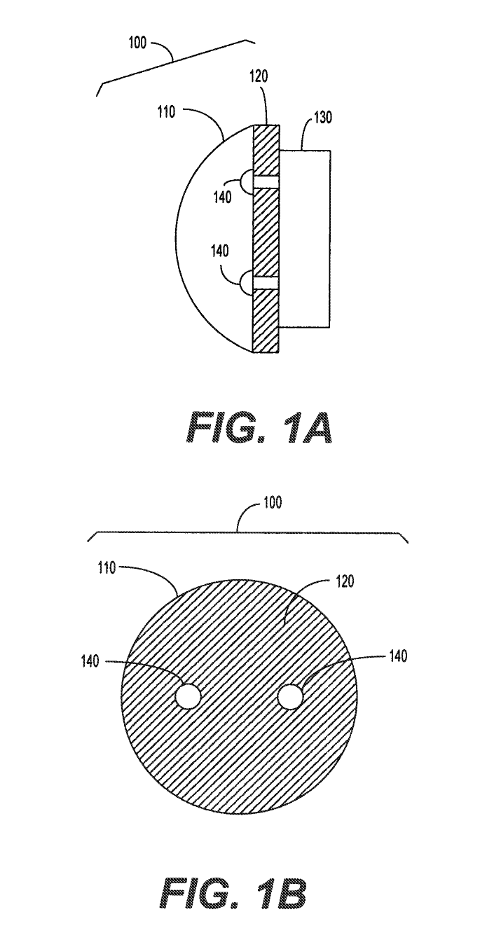

FIG. 1(a) illustrates a side-view input mechanism 100 employing a lens 110 and a finishing layer 120. FIG. 1(b) illustrates a front-view of the input mechanism 100.

Referring to FIGS. 1(a) and 1(b), the input mechanism 100 includes a lens 110, a finishing layer 120, and an actuator mechanism 130. The lens 110, in response to being touched or having pressure asserted to the lens 110, transfer the pressure to the actuator mechanism 130. The transferred pressure may then cause the actuator mechanism 130 to generate an electrical signal. The electrical signal may then instigate an operation of the consumer device associated with the input mechanism 110.

As shown in FIGS. 1(a) and (b), the lens 110 and finishing layer 120 are attached to the input mechanism 130 via a mechanical fastening technique 140. The mechanical fastening technique 140 may be any sort of bolt, screw, or attachment piece.

However, while employing the mechanical fastening technique 140, the lens 110, which is transparent, shows portions of the mechanical fastening technique 140. Further, the finishing layer 120, which may be any sort of paint, is discontinuously presented. The discontinuous presentation may serve to be unappealing and mute the aesthetic gains appreciated by employing the lens 110.

Disclosed herein are devices and methods to avoid the phenomena caused by the mechanical fastening technique 140. Specifically, the aspects disclosed herein are directed to an adhesively attached lens with a finishing layer. By employing an adhesive layer, the input mechanism realizes an edge-to-edge appearance aided by the finishing layer 120, without experience any sort of discontinuation caused by a mechanical fastening technique 140. In this way, the implementer of the input mechanism disclosed herein may realize a greater aesthetic finished product.

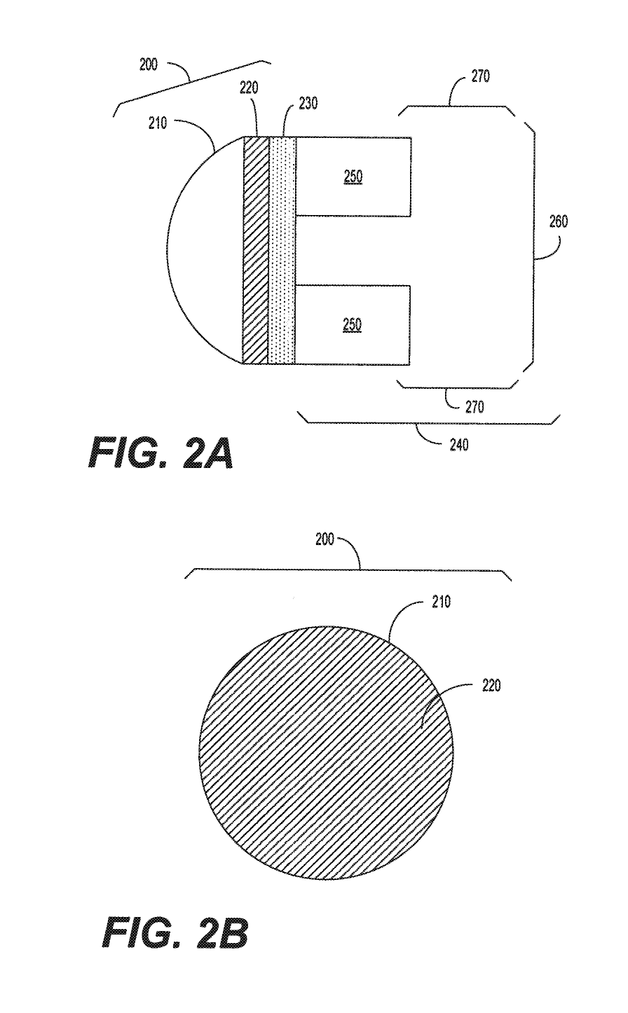

FIG. 2(a) illustrates a side-view of an input mechanism 200 according to the aspects disclosed herein. FIG. 2(b) illustrates a front-view of the input mechanism 200.

The input mechanism 200 includes a lens 210, a finishing layer 220, and an adhesive layer 230. The adhesive layer 230 affixes the lens 110 and the finishing layer 220 to a mechanical fastening technique 240.

The mechanical fastening technique 240 includes a sub-retainer 250, a button retainer 260, and a sliding frame 270. The sliding frame 270 may be provided along with a bezel (not shown).

Specifically, the adhesive layer 230 may be applied on either the finishing layer 220, or the sub-retainer 250. In either case, in response to asserting pressure on the lens 210 with the sub-retainer 250, the adhesive layer 230 bonds the two parts together.

The adhesive layer 230 may be transparent, or significantly allow light to pass through. Alternatively, the adhesive layer 230 may have an opening, allowing light to pass through, thereby illuminating the finishing layer 220.

In response to a user of the input mechanism 200 asserting force on to the lens 210, for example, via a touch, the lens 210 moves, thereby causing the sub-retainer 250 to move as well. The sub-retainer 250, after sliding via the sliding frame 270, may contact the button retain 260, and cause the button retainer to actuate an electronic signal. The electronic signal, in turn, may operate the consumer device. For example, if the input mechanism 200 is implemented in a vehicle, the input mechanism 200 may cause an audio device to turn on.

Thus, because the adhesive layer 230 is employed for the purposes of attaching the lens 210 to the sub-retainer 250, an effect shown in FIG. 1 is avoided. The finishing layer 220 is substantially “edge-to-edge” and continuous in presentation. In this way, the input mechanism 200 may be more aesthetically pleasing than the input mechanism 100 depicted in FIG. 1.

The mechanical fastening technique 240 is merely exemplary. One of ordinary skill in the art may implement any sort of button technique to actuate the electronic signal.

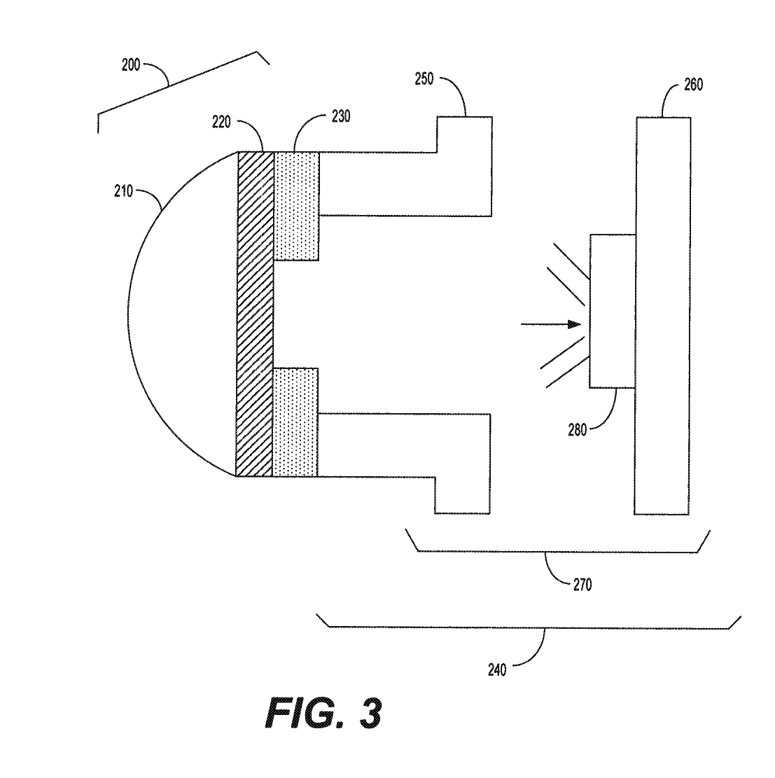

FIG. 3 illustrates a side-view of an input mechanism 200 according to another example implementation.

The input mechanism 200 shown in FIG. 3 is substantially similar to the one shown in FIGS. 2(a) and 2(b). However, the input mechanism 200 now incorporates a lighting source 280. The lighting source 280 backlights the input mechanism 200, thereby illuminating the finishing layer 220, and providing a brighter and clearer interface to an operator of the input mechanism 200.

In contrast to the input mechanism 100 shown in FIGS. 1(a) and 1(b), an advantage is realized when implementing input mechanism 200. A phenomena called light leakage occurs with input mechanism 100. Light leakage is caused by the areas around the mechanical fastening technique 140. Due to the discontinuous appearance caused by the mechanical fastening technique 140 and the finishing layer 120 being provided together, light from the lighting source 280 may inadvertently leak out. Incomplete edge to edge decorating coverage of finishing layer 120 can also cause a lightleak from lighting source 280 being visible as a lack of opaque paint is present at the edges.

On the contrary, the input mechanism 200 depicted in FIGS. 2(a), 2(b) and 3 does not realize this phenomena. Because the finishing layer is continuous (“edge-to-edge”), no light leakage occurs.

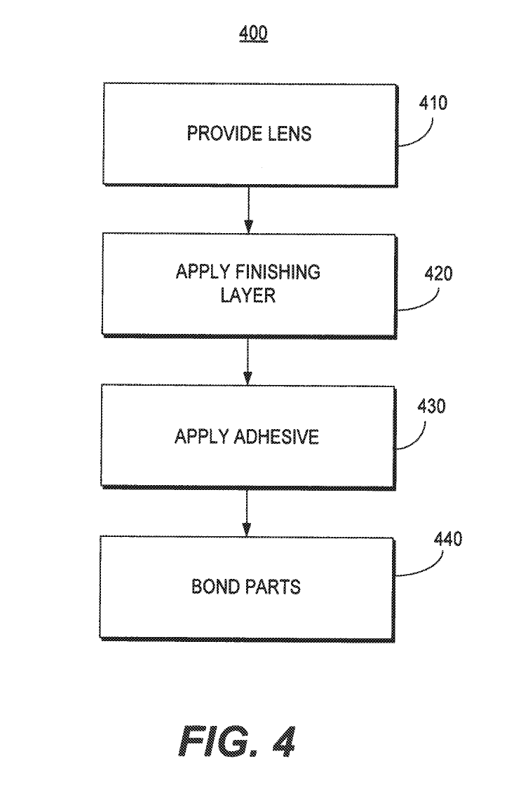

FIG. 4 illustrates a method 400 for providing an edge-to-edge input mechanism. The method 400 may be accomplished through an automated process, via machinery and an assembly process. Alternatively, the method 400 may be practiced by an individual manually assembling the input mechanism.

In operation 410, a lens for use with the interface of the input mechanism is provided. The lens may be any sort of transparent, or partially transparent surface. As explained above, the lens may enhance the aesthetic design of the input mechanism.

In operation 420, a finishing layer may be applied to the lens. The finishing layer is a paint layer used to augment the lens with a specific color. The finishing layer may allow light to pass through, therefore creating a glowing effect.

In operation 430, an adhesive is applied. The adhesive may be applied to a structure, such as a sub-retainer discussed above. Alternatively, the adhesive may be applied to the finishing layer.

In operation 440, the input mechanism is fully assembled by bonding the lens, the finishing layer and the sub-retainer structure. The resultant device forms an input mechanism, such as input mechanism 200 described above.

Thus, according to the aspects disclosed herein, a device implementing the input mechanisms described in FIGS. 2-4 may realize an edge-to-edge appearance of a decorative paint layer. Thus, the input mechanism may be presented with a greater aesthetic appeal.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

We claim:

1. An input mechanism device, comprising:
a lens at a surface facing an engager of the input mechanism;
a finishing layer opposite the surface, applied on the lens;
an adhesive layer on the finishing layer;
a sub-retainer, the sub-retainer and the adhesive layer being bonded with each other via adhesive properties associated with the adhesive layer; and
a button retainer to engage with the sub-retainer in response to the engager of the input mechanism applying pressure on the lens.

2. The device according to claim 1, wherein the lens is transparent.

3. The device according to claim 1, wherein the finishing layer is substantially edge-to-edge.

4. The device according to claim 1, wherein the adhesive layer is transparent.

5. The device according to claim 3, wherein the finishing layer includes a decorative finish.

6. An input mechanism device, comprising:
a lens at a surface facing an engager of the input mechanism,
a finishing layer opposite the surface, applied on the lens;
an adhesive layer on the finishing layer;
a sub-retainer, the sub-retainer and the adhesive layer being bonded with each other via adhesive properties associated with the adhesive layer;
a button retainer to engage with the sub-retainer in response to the engager of the input mechanism applying pressure on the lens; and
an illumination source to illuminate the finishing layer with light.

7. The device according to claim 6, wherein the lens is transparent.

8. The device according to claim 7, wherein the finishing layer is substantially edge-to-edge.

9. The device according to claim 6, wherein the adhesive layer is transparent.

10. The device according to claim 8, wherein the finishing layer includes a decorative finish.

11. The device according to claim 6, wherein the adhesive layer includes an opening, the opening allowing the light to pass onto the finishing layer.

12. A method for providing an edge-to-edge input mechanism, said method comprising:
providing a lens to be an interface of the edge-to-edge input mechanism;
applying a finishing layer on a surface opposite a front surface of the lens;
applying an adhesive layer on the finishing layer; and
bonding the finishing layer with a sub-retainer via the adhesive layer,
wherein the sub-retainer engages with a button retainer in response to pressure being applied to the lens.

13. The method according to claim 12, wherein the lens is transparent.

14. The method according to claim 12, wherein the finishing layer is substantially edge-to-edge.

15. The method according to claim 12, wherein the adhesive layer is transparent.

16. The method according to claim 12, further comprising applying a decorative finish via the finishing layer.
